(19) United States
(12) Patent Application Publication
(10) Pub. No.: US 2005/0268765 A1
(43) Pub. Date: Dec. 8, 2005

(54) Reciprocal bi-directional table saw

(76) Inventor: Chun-Jen Chien, I-Lan Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/860,001

(22) Filed: Jun. 4, 2004

(51) Int. Cl. B26D 5/00; B26D 1/14; B23D 19/00; B23D 33/02; B23D 7/00; B27B 19/00

(52) U.S. Cl. 83/471

(57) ABSTRACT

A reciprocal bi-directional table saw including a cutting table and a deck to secure a work piece in place; the table including a horizontally provided runway and a cutting process unit that automatically travels back and forth on the runway; an automatic travel device being each provided on both sides of a seat plate provided to the cutting process unit; a saw blade elevates as controlled by a plunger having one side pivoted to the seat plate; a circular saw blade and a device to drive the circular saw blade being provided on the saw blade holder for the table saw to reciprocally execute the cutting on the work piece to achieve precise process of the work piece and upgrade the production rate.

### BACKGROUND OF THE INVENTION

(a) Field of the Invention

The present invention is related to a reciprocal bi-directional table saw, and more particularly, to one with a work piece clamped in position while a circular saw blade travels to cut for the circular saw to elevate.

(b) Description of the Prior Art

Table sawing machines generally available in the market are available in many types. Some are dedicated depending on function for cutting specified materials, such as metal, wooden, cement or building materials; while others vary according to type and assembly of saw blade such as band saw, saw blade, horizontal or vertical assembly). In addition, there are also sawing machines classified depending on whether the work piece is fixed in place or not. Within, taking the table saw to cut handle materials for instance, the saw blade is usually fixed in position while the work piece is moved close to the saw blade for cutting. The operator has to manually push the wooden piece towards the saw blade for process. However, this type of sawing machine consumes a lot of efforts and is applicable only to process wood in smaller size. It fails to handle larger and heavier logs or excessively long boards. Therefore, such fixed type of table saw has a limited scope of application.

Furthermore, a table saw provided with a circular saw blade of the prior art is mobile to cut wood. Wherein, the wood is fixed in place with clamps from a locking machine; the wood is trimmed to rid of excessive parts, or cut into the shape or dimension as desire by a circular saw blade fixed on a runway to travel and rotate. However, this type of table sawing machine for being limited to the relatively optimal cutting angle between the circular saw blade and the wood has to be fixed in position; accordingly it travels to cut only in one direction and is prevented from cutting while on its returning trip.

### SUMMARY OF THE INVENTION

The primary purpose of the present invention is to provide a table saw that reciprocally cuts in both directions. To achieve the purpose, the holder of the circular saw blade is design such to ascend or descend to a present level, and permit the cutting angle between the circular saw blade and the wood for a rotary cut into the wood either in forward or backward direction for reaching the purpose of cutting cut of the work piece in the reciprocal trip of the circular saw blade.

Another purpose of the present invention is to provide a table saw that fast and firmly clamps a work piece in position and allows the adjustment of the cutting amount or dimension of the work piece for an easier and convenient operation of the cutting process.

To achieve the purpose, the table saw includes a sawing table, a deck to secure the work piece in position. Wherein, the deck relates to a console that holds the work piece in position and is capable of adjusting the cutting amount or dimension of the work piece. The sawing table provided by the side of the deck includes a horizontal runway and a cutting process unit that reciprocally and automatically travels on the runway. The automatic travel device is each provided on both sides of a seat plate of the cutting process unit, and a saw blade holder with its one end pivoted to be controlled by a plunger member to ascend or descend is provided on the seat plate. A circular saw blade and a device required to drive the saw blade are provided on the saw blade holder. Accordingly, both of the relative cutting angle and position between the circular saw blade and the work piece can be adjusted during the reciprocal trips of the cutting process unit to execute the reciprocal cut on the work piece in both direction to provide the cutting results that yield precise dimensioning of the work piece, efforts saving in the cutting and upgraded production rate.

### BRIEF DESCRIPTION OF THE DRAWINGS

FIG. 1 is a perspective view of a preferred embodiment of the present invention as assembled.

FIG. 2 is a schematic view showing that the preferred embodiment of the present invention is operating in its forward trip.

FIG. 3 is a schematic view showing that the preferred embodiment of the present invention is operating in its backward trip.

FIG. 4 is a schematic view showing the operation of an adjustment device adapted to the preferred embodiment of the present invention.

FIG. 5 is a schematic view showing the operation of a rest device adapted to the preferred embodiment of the present invention.

FIG. 6 is a schematic view showing the operation of a clamping device adapted to the preferred embodiment of the present invention.

FIG. 7 is a schematic view showing that a work piece is secured in position by the clamping device of the preferred embodiment of the present invention.

FIG. 8 is a schematic view showing that the rest device of the preferred embodiment of the present invention is retreated.

FIG. 9 is a schematic view showing a status of the rest device of the preferred embodiment of the present invention before its operation.

FIG. 10 is a schematic view showing a status of the rest device of the preferred embodiment of the present invention after its operation.

FIG. 11 is a schematic view showing a status of the clamping device of the preferred embodiment of the present invention before its operation.

FIG. 12 is a schematic view showing a status of the clamping device of the preferred embodiment of the present invention after its operation.

FIG. 13 is a schematic view showing a circular blade of the preferred embodiment of the present invention cuts the work piece in its forward trip.

FIG. 14 is a schematic view showing a circular blade of the preferred embodiment of the present invention cuts the work piece in its backward trip.

FIG. 15 is a schematic view showing the incorporation of the circular saw blade in another preferred embodiment of the present invention.

FIG. 16 is a schematic view showing the incorporation of the circular saw blade in another preferred embodiment yet of the present invention.

### DETAILED DESCRIPTION OF THE PREFERRED EMBODIMENTS

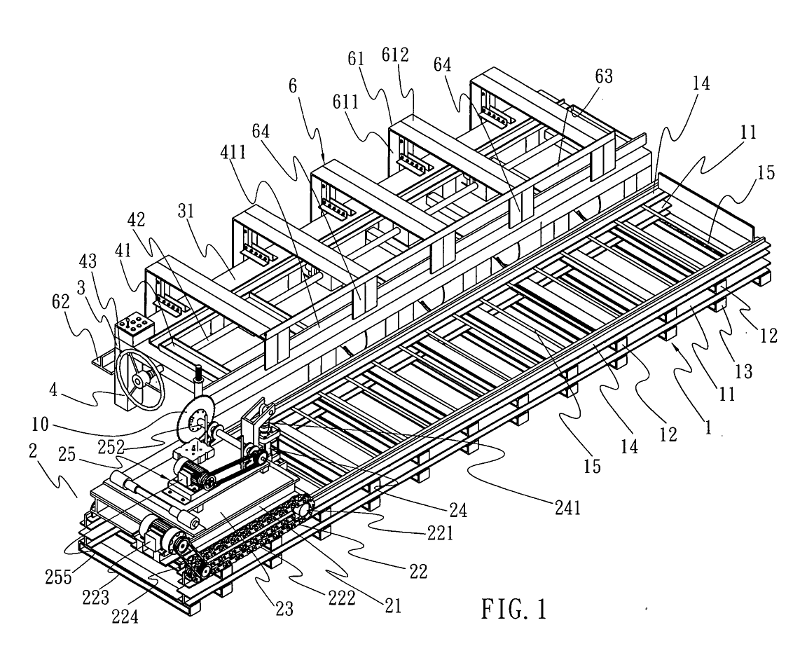

Referring to FIGS. 1, 2, and 3, a reciprocal bi-directional table saw relates to one that has a work piece clamped in position and a circular saw blade 10 is used to cut the work piece reciprocally in two directions. When applied to cut a board or similar work piece, a preferred embodiment of the present invention is essentially comprised of a table and a deck to secure the work piece in position. Wherein, the table related to a mechanism for the circular saw blade 10 in linear movement to execute the sawing work is comprised of a runway 1 and a cutting process unit 2. Wherein, the runway 1 as illustrated in FIG. 1, bears the cutting process unit 2 and guides it to travel back and forth. The runway 1 is comprised of multiple rails. A strip rail base 11 is each provided on both sides of a lower deck of the runway. Multiple ties 12, 13 are respectively provided on and beneath the rail base 11. Both rail bases 11 are arranged in parallel to each other and separated from each other for a proper spacing. Two rails 14 are provided on the upper ties 12 and multiple adjusting worms 15 are screwed at where between two rails 14 to adjust the spacing and parallel between two rails 14 as desired.

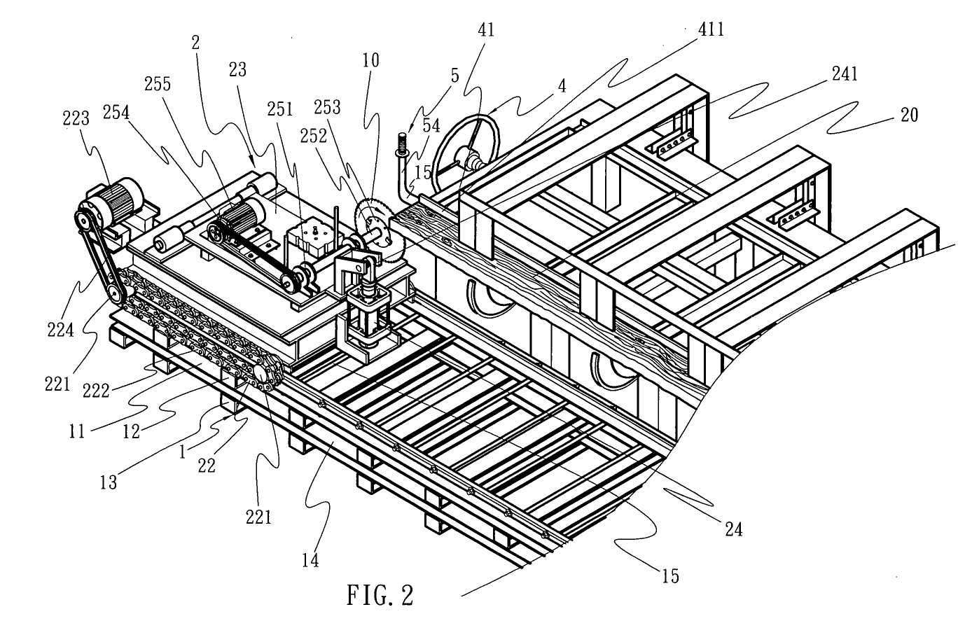

The cutting process unit 2 as illustrated in FIG. 2 allowing the circular saw blade 10 to be moved to work piece and rotate to cut the work piece is essentially comprised of a seat plate 21 respectively adapted on its both sides an automatic travel device 22; and a saw blade holder 23 with one side pivoted to ascend or descend in position is provided on the seat plate 21. An automated plunger 24 is fixed to where appropriately on the seat plate 21 and the plunger 24 may be provided in a structure of an air or hydraulic cylinder or any other structure that permits retractable motion. An active end 241 of the plunger 24 is connected to an end not pivoted as illustrated of the saw blade holder 23 so that the saw blade holder 23 may swing to indicate multiple heights. The circular saw blade 10 and a drive device 25 required to drive the circular saw blade 10 are provided on the saw blade holder 23.

As illustrated in FIG. 2, the automatic travel device 22 each provided on both sides of the seat plate 21 includes two rollers 221 linked to each other with a chain 222. A motor 223 is fixed to the rear end of the seat plate 21 and a belt 224 transmits the kinetics from the revolving motor 223 to either roller 221 for the automatic travel device 22 to move along the rails 14. The drive device 25 as illustrated in FIG. 2, includes a rotary, horizontally provided tooling main shaft 252, a locking disk 253 is provided at one end of the tooling main shaft 252 for the adaptation of the circular saw blade 10, and a transmission unit 254 in the form of a belt and a belt gear set is disposed to the body or the other end of the tooling main shaft 252 to link to another motor 255 provided on the saw blade holder 23. Consequently, the motor 255 drives the tooling main shaft 252 to further drive the circular saw blade 10 to synchronously rotate and cut.

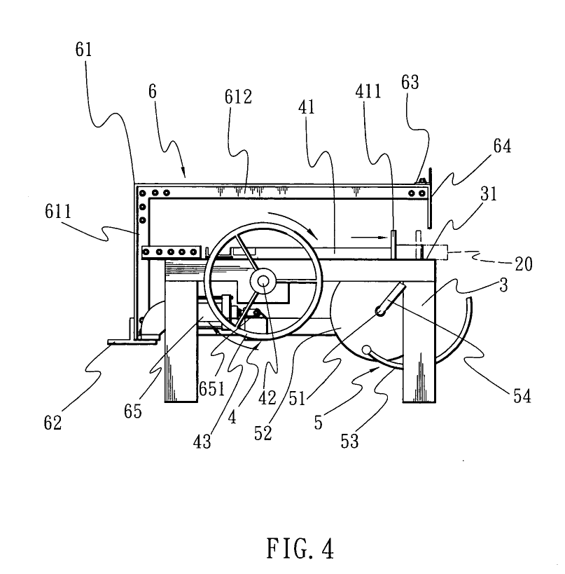

The fixed deck whereon the workplace is clamped in position as illustrated in FIGS. 1 and 4 is comprised of a table 3, an adjustment device 4, a rest device 5 and a clamping device 6. Wherein, the table 3 relates to a rectangular table fabricated with multiple steel bars provided with a top 31 for the placement of the work piece and the adjustment device 4 is disposed on the top 31 of the table 3.

The adjustment device 4 as illustrated in FIGS. 1 and 4 is provided with a long plunge frame 41 disposed on the top 31 of the table 3, a stick positioning plate 411 disposed to the front of the plunge frame 41 defines a reference plane for the work piece to rest upon, and a shaft 42 and a transmission hand wheel 43 are provided to the plunge frame 41 with the hand wheel 43 extending through one end of the table 3. Accordingly, the plunge frame 41 advances or retreats as controlled by the hand wheel 43 and the shaft 42.

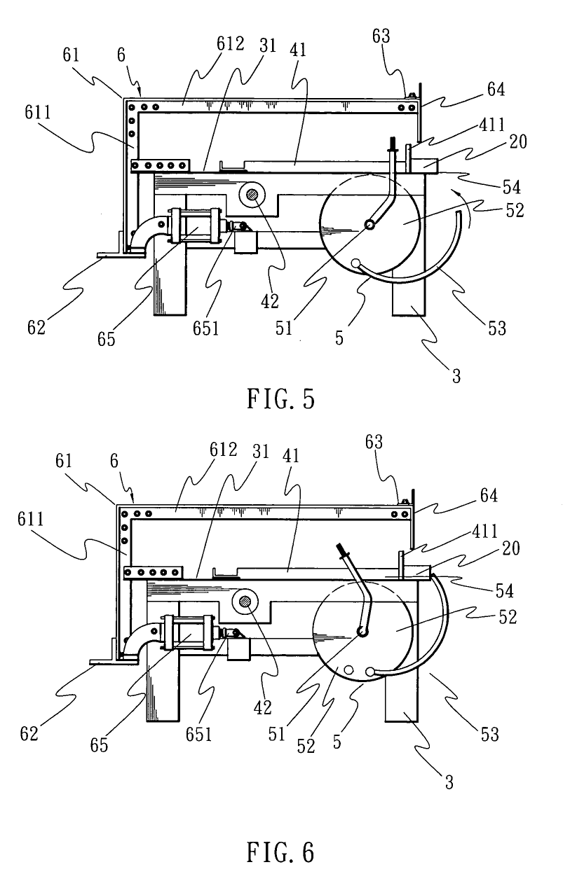

The rest device 5 relates to a manual device provided for the work piece to rest tightly to the positioning plate 411 in the front of the plunge frame 41 as illustrated in FIGS. 1 and 5. A rotary shaft 51 is mounted to where below the front of the table 3, multiple turntables 52 are provided to the body of the rotary shaft 51, an arc push rod 53 is disposed to each turntable 52 and extends to where below the front of the table 3, and a pull rod 54 is disposed at one end of the rotary shaft 51. Consequently, the rotary shaft 51 and the turntable 52 rotate as driven manually to further cause the push rod 53 to press against a work piece 20 resting on the positioning plate 411.

As illustrated in FIGS. 1 and 5, the clamping device 6 holding the work piece 20 in place from its top is related to an angular frame 61 including a vertical section 611 and a horizontal section 612, two connection rods 62, 63 are respectively disposed to where appropriately on the vertical and the horizontal sections, 611, 612, the vertical section 611 of the angular frame 61 is pivoted to the rear end of the table 3, the horizontal section 612 is located at where above the table 3, and a clamping board 64 is provided to the front of the horizontal section 612 at where merely above the front of the positioning plate 411. Consequently, when the angular frame 61 swings, the clamping board 64 presses down to clamp the work piece 20 as illustrated in FIG. 6. An automatic plunger 65 in a form of air cylinder, hydraulic cylinder or any other structure that provides retractable motion is provided to the connection rod 63 disposed at the vertical section 611 of the angular frame 61, and an active end 651 of the plunger 65 is fixed to the table 3 so to control the swing of the angular frame 61 for the clamping board 64 to hold the work piece 20 in position as the plunger 65 retracts.

The present invention with its structural characteristics of a table and a deck with the runway 1 provided on the front of the table 3, the cutting process unit 2 adapted with the circular saw blade 10 provided on the front of the top 31 of the table 3 to constitute a reciprocal, bi-directional table saw. Wherein, the work piece 20, e.g., a wood, is secured on the table 3, and the cutting process unit 2 automatically advances and retreats for the circular saw blade 10 to cut the work piece 20.

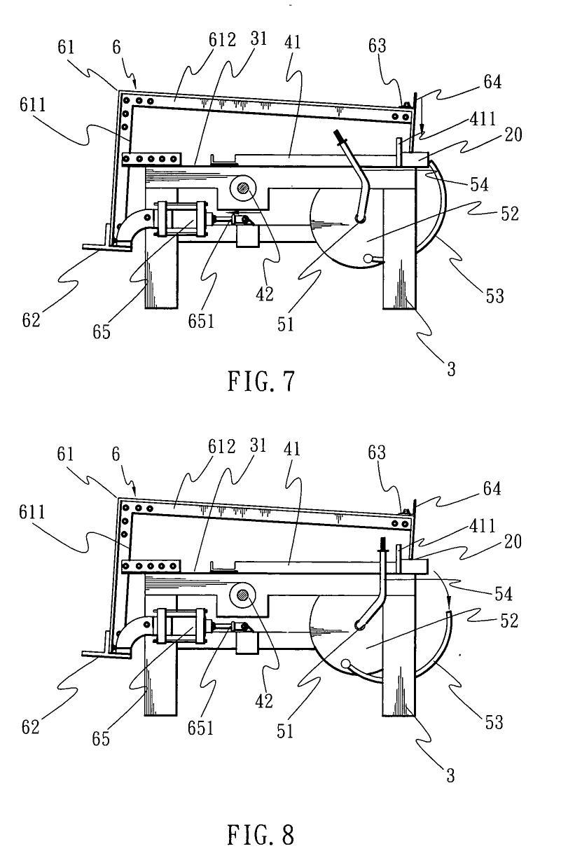

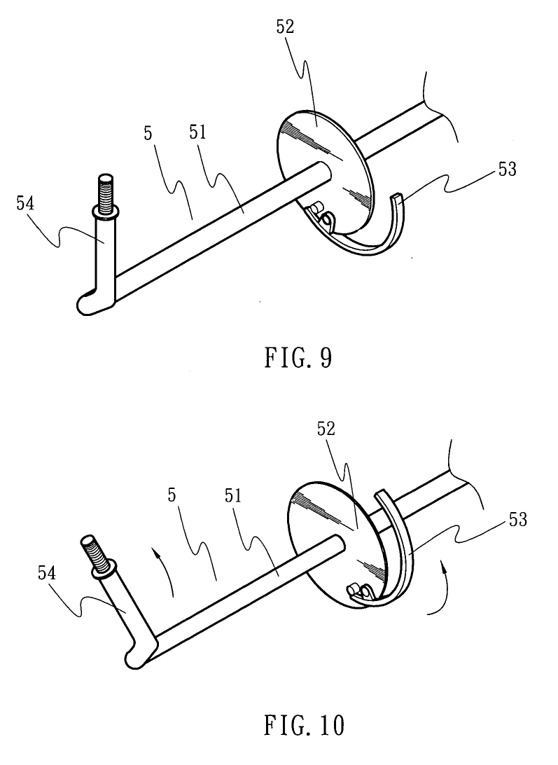

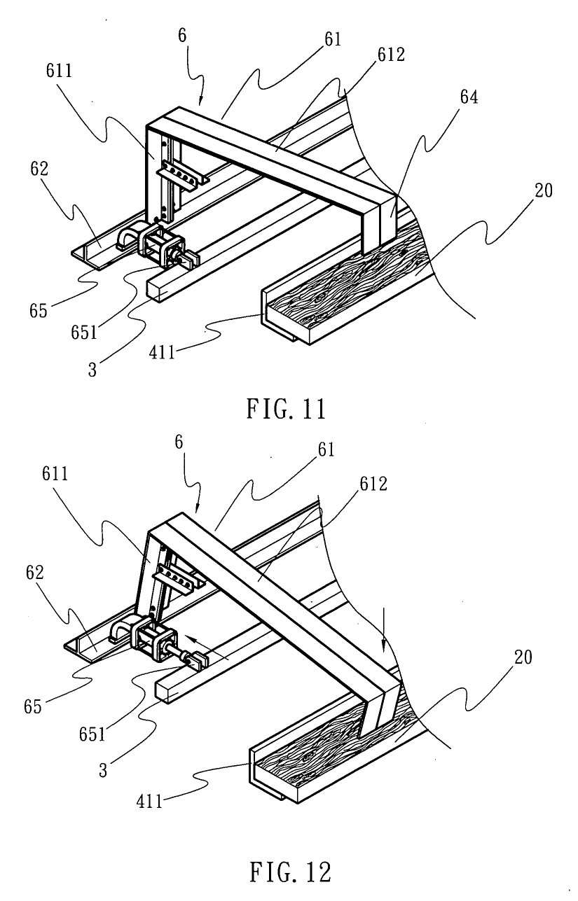

By presetting the adjustment device 4 for its positioning plate 411 to locate at where appropriately on the top 31 of the table 3 as illustrated in FIG. 4, the work piece 20 is secured on the front side of the top 31 of the table 3 as illustrated in FIG. 7, the rest device 5 is then pulled to rotate its push rod 53 as illustrated in FIGS. 9 and 10, the push rod 53 in turn plunges against the work piece 20 to hold against the positioning board 411 of the adjustment device 4 on the back as illustrated in FIG. 7, and by controlling the adjustment device 4 once again for the work piece 20 to protrude out of the front of the table 3 for a proper length, the plunger 65 of the clamping device 6 is activated as illustrated in FIGS. 11 and 12 for the angular frame 61 to swing, thus for the clamping board 64 of the horizontal section 612 to press down to clamp the work piece 20 before the rest device 5 is rotated to retreat the push rod 53 as illustrated 8 to complete the piloting operation of securing the work piece 20 and presetting the dimension of the work piece 20.

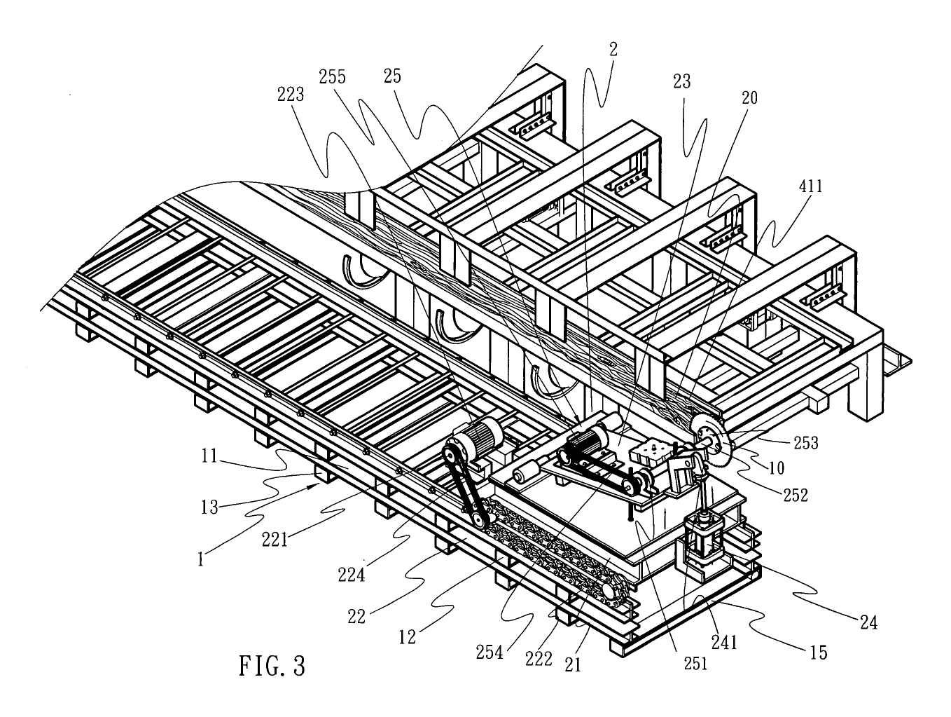

The cutting process unit 2 of the present invention advances on the runway 1 while the circular saw blade 10 starts to rotate, and the saw blade holder 23 descends onto the seat plate 21 as plunged by the plunger 24 for the circular saw blade 10 to maintain at a proper height with its upper front edge aligned at the work piece 20 as illustrated in FIG. 2. Accordingly, the progressive on one-way trip of cutting commences to cut of the excessive part of the work piece 20 and to cut the work piece 20 in a preset shape and dimension. Upon the returning trip of the cutting process unit 2, the plunger 24 is controlled to such that the saw blade holder 23 erects over the seat plate 21 to elevate the circular saw blade 10 with its lower back edge aligned at another plane of the work piece 20 as illustrated in FIG. 3 or a new work piece 20′ is immediately replace to be process at the same time when the cutting process unit 2 is on its returning trip. Therefore, the present invention achieves the purpose of upgrading production benefits by reciprocal cutting, which cannot be achieved by the prior art.

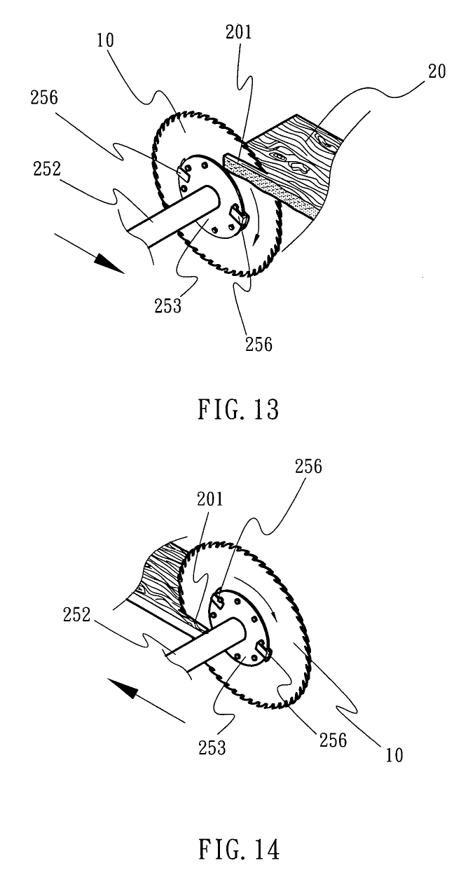

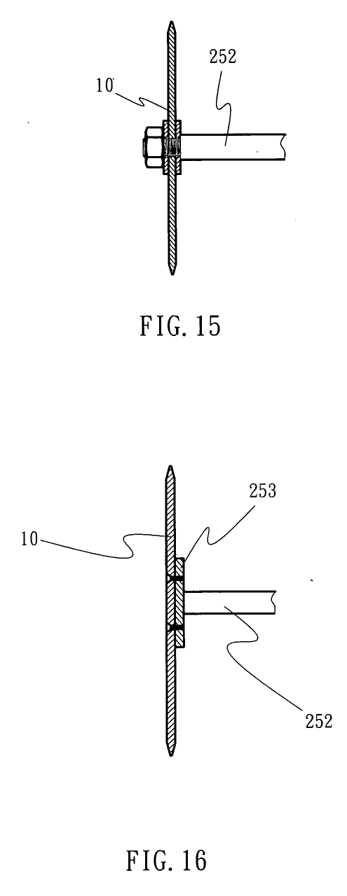

Now referring to FIGS. 13 and 14, on the back of the locking disk 253 to lock the circular saw blade 10 in place of the present invention is disposed with one or multiple strikes 256 and the strike 256 extends out of the circumference of the locking disk 253 so to knock off waste wood 201 cut from the work piece 20 to facilitate the process as the circular saw blade 10 is cutting the work piece 20 by preventing accumulation of waste wood 201 at the cutting process unit 2. As illustrated in FIG. 15, the circular saw blade 10 of the present invention is working on a sectional cutting process, and as illustrated in FIG. 16, the circular saw blade 10 of the present invention is trimming the surface of the work piece: Provided, however, that these two process fashions only involve the adaptation of the circular saw blade 10.

It is to be noted that the present invention is essentially characterized by the configuration of the assembly of the cutting process unit 2 that permits the circular saw blade 10 to cut the work piece 20 upon traveling back and forth on the runway 1; and that the shape and structure each of the runway 1, the table 3, the adjustment device 4, the rest device 5 and the clamping device 6 may vary without being limited to those disclosed. Therefore, any summary change and/or replacement based on the structural characteristics of the cutting process unit 2 of the present invention shall fall within the scope of the claims claimed under the present invention.

1. A reciprocal bi-directional table saw including a cutting table and a deck to fix a work piece is characterized by that the cutting table is comprised of a runway and a cutting process unit; wherein, the runway being related to a structure that provided with a rail to bear and guide the cutting process unit to travel back and forth; the cutting process unit related to a cutting mechanism that causes one or multiple circular saw blades to reciprocally travel and rotate to cut being comprised of a seat plate having it both sides disposed each an automatic travel device required for the cutting process unit to travel back and forth on the rail, a saw blade holder having its one side pivoted to ascend or descend in position being provided to the seat plate, an automatic plunger being fixed to the seat plate, an active end of the plunger being linked to the saw blade holder, the saw blade holder swinging to indicate two or more than two selected heights; one or multiple circular saw blades being disposed to the saw blade holder; a device to drive the saw blade being also disposed to the saw blade holder; and the cutting by the circular saw blade being permitted as the cutting process unit travels back and forth.

2. A reciprocal bi-directional table saw as claimed in claim 1, wherein, the automatic travel device includes two rollers provided on both sides of the sea plate, both rollers being interlinked by a chain, a motor is fixed to the seat plate, and a belt being provided to transmit the kinetics from the motor to either roller.

3. A reciprocal bi-directional table saw as claimed in claim 1, wherein, the device to drive the saw blade includes a tooling main shaft rotating and horizontally provided on the saw blade holder; a locking disk being provided at one end of the tooling main shaft and adapted to the circular saw blade, the tooling main shaft being linked to a motor provided on the saw blade holder through a transmission unit elsewhere on the tooling main shaft, and the tooling main shaft rotating synchronously as driven by the motor.

4. A reciprocal bi-directional table saw as claimed in claim 3, wherein, the locking disk includes one or multiple strikes disposed on the back of the locking disk; and the strike being extending out of the circumference of the locking disk.

5. A reciprocal bi-directional table saw as claimed in claim 1, wherein, the rail is comprised of multiple steel bars, a strip rail base being each provided on both sides of a lower deck of the rail, multiple ties being respectively provided on and beneath the rail base; both rail bases being separately from each other in parallel; two trails being provided over the ties;
and multiple adjustment worms being provided between both rails for the adjustment of the spacing and parallel of both rails as desired.

6. A reciprocal bi-directional table saw as claimed in claim 1, wherein, the deck to secure a work piece in position is comprised of a table, an adjustment device, a rest device and a clamping device; wherein, the table provided with a top for the placement of the work piece; the adjustment device including a plunge frame disposed on the top of the table, a positioning plate being provided in front of the plunge frame to define a reference plane for the work piece to rest against; a shaft and a hand wheel being provided to the plunge frame with the shaft penetrating through to reach an end of the table to control the plunge frame to advance or retreat; the rest device containing a turning shaft mounted in the lower front of the table; multiple turntables being disposed to the body of the shaft; an arc push rod extending to where below the front of the table being each provided to the turntable; a pull rod being disposed to one end of the shaft; and the shaft and the turntable being turned for the push rod to hold against the work piece to rest on the positioning plate; and the clamping device being provided with an angular frame including a vertical section and a horizontal section; the vertical section being pivoted to the rear of the table; the horizontal section being at where above the table; a clamping board being disposed to the front end of the horizontal section to be merely located at where above the front of the positioning plate; and the clamping board pressing down to clamp the work piece as the angular frame swings subject to a plunger.
